(19) United States
(12) Patent Application Publication
(10) Pub. No.: US 2015/0159699 A1
(43) Pub. Date: Jun. 11, 2015

(54) Driveline Components for a Motor Vehicle and Method of Assembly

(71) Applicant: Ford Global Technologies, LLC, Dearborn, MI (US)

(72) Inventors: Damien Baldwin, Belleville, MI (US); Jeff Dumler, Wolverine Lake, MI (US)

(73) Assignee: Ford Global Technologies, LLC, Dearborn, MI (US)

(21) Appl. No.: 14/101,551

(22) Filed: Dec. 10, 2013

(51) Int. Cl. F16D 1/08; B60K 23/08

(52) U.S. Cl. CPC F16D 1/08; B60K 23/08; B60K 2023/0891

(57) ABSTRACT

While assembling driveline components for a motor vehicle, one driveline component is rotated relative to another driveline component until the driveline components are properly aligned. This rotation is accomplished through the use of a fastener, which also helps secure the driveline components to one another. The fastener is preferably a lock nut, and, more specifically, a prevailing torque nut. In one embodiment, the fastener requires at least 20 Nm of force in order to be run down on one of the driveline components. Running down and tightening the fastener occurs during the final assembly step of the driveline components relative to one another. The alignment of the driveline components preferably takes place between splines of one driveline component and splines of the other driveline component.

### BACKGROUND OF THE INVENTION

1. Field of the Invention

The present invention pertains to the art of assembling driveline components for motor vehicles, and, more particularly, to the rotation of driveline components during assembly in order to ensure proper alignment of the components.

2. Background of the Invention

In a typical four-wheel drive vehicle, an engine delivers torque to a transmission, which in turn delivers the torque to a transfer case. The transfer case divides the torque between a primary driveshaft and a secondary driveshaft (e.g., rear and front driveshafts), thereby selectively rotating the primary and secondary driveshafts. The transfer case operates in several different drive modes that determine the manner in which the transfer case delivers torque to the primary and secondary driveshafts. These modes typically include a two-wheel drive operating mode, in which all of the torque from the input shaft is delivered to the primary or rear driveshaft, and one or more four-wheel drive operating modes (e.g., four-wheel drive high and low modes), in which the transfer case provides torque to all four wheels.

Four-wheel drive vehicles also typically include mechanisms that enable the front wheels to be selectively connected and disconnected from the vehicle's front or secondary driveline. These mechanisms are activated as the vehicle is shifted from a two-wheel drive mode to a four-wheel drive mode, thereby allowing the torque from the front driveshaft to be communicated to the front wheels. Oftentimes, the mechanisms are automatically actuated by use of a controller or control system. In one arrangement, the connection and disconnection of the front wheels is accomplished by moving a splined ring gear back and forth via a shift fork. In the two-wheel drive mode, the splines of the ring gear mesh only with the splines of a front half shaft. In the four-wheel drive mode, the splines of the ring gear mesh with both the splines of the front half shaft and splines formed on a portion of a front hub bearing assembly. When in four-wheel drive mode, rotation of the front half shaft will cause rotation of the front hub bearing assembly. As a result, the front wheel coupled to the front hub bearing assembly will also rotate.

During assembly of a vehicle having such a system, it is important that all driveline components are properly aligned. For example, it is important that the splines of the front half shafts are properly aligned with the splines of the front hub bearing assemblies when each front hub assembly is attached to the vehicle and secured with a fastener. Conventionally, as an operator assembles the components, each front hub assembly is slid onto the half shaft such that one end of the half shaft is inserted into the hub bearing assembly. Upon initial insertion, the half shaft and hub bearing assembly splines may not be aligned properly. Additionally, even if the half shaft is aligned with the hub bearing assembly, it is possible for the two components to move back out of alignment. For example, this could occur if the operator, or some other object, bumps one of the components. Regardless, if the splines are not aligned, then the operator will not be able to fully insert the half shaft. At this point, the operator will need to rotate the half shaft relative to the hub bearing assembly until the splines of each are aligned. When this occurs, the half shaft can be moved so as to become fully inserted into the hub bearing assembly. However, in some cases, the operator does not initially notice that the components are misaligned during insertion, and, therefore, does not perform the required rotation.

If the components are not aligned during a run down and tightening of the fastener that couples them together, either because they were never aligned or because they were aligned but became misaligned, then the shift fork will be deflected and can fracture. This will lead to noise, vibration and harshness concerns for a driver of the vehicle. Specifically, the noise, vibration and harshness are caused by the ring gear, which moves freely when not held in place by the shift fork. Even more importantly, if the shift fork fails totally as a result of misalignment during assembly, then the vehicle will be unable to shift into the four-wheel drive mode.

Based on the above, there exists a need in the art for a way to ensure that proper alignment is maintained between driveline components during the assembly process.

### SUMMARY OF THE INVENTION

The present invention is directed to assembling driveline components for motor vehicles wherein one driveline component is rotated relative to another driveline component until the driveline components are properly aligned. This rotation is accomplished through the use of a fastener, preferably the same fastener used to secure the driveline components to one another. The fastener is preferably a lock nut, and, more specifically, a prevailing torque nut. In a preferred embodiment, the fastener requires at least 20 Nm of force in order to be run down on one of the driveline components. Running down and tightening the fastener occurs during an assembly step of the driveline components relative to one another. The alignment of the driveline components preferably takes place between splines of one driveline component and splines of the other driveline component. In the preferred embodiment, the driveline components are a half shaft and a hub bearing assembly, with the half shaft being rotated relative to the hub bearing assembly.

Additional objects, features and advantages of the present invention will become more readily apparent from the following detail description of preferred embodiments when taken in conjunction with the drawings wherein like reference numerals refer to corresponding parts in the several views.

### BRIEF DESCRIPTION OF THE DRAWINGS

FIG. 1 is a schematic view of a vehicle driveline in accordance with the present invention;

FIG. 2 is a perspective, exploded view of a front left wheel end assembly in accordance with the invention;

FIG. 3 is a cross-sectional view of the wheel end assembly;

FIG. 4 is a partial cross-sectional view of FIG. 3 showing splines not in alignment during assembly;

FIG. 5 is a partial cross-sectional view of FIG. 3 showing splines in alignment;

FIG. 6 is a partial cross-sectional view of FIG. 3 when a vacuum is applied to a vacuum line;

FIGS. 7A-7D showing details of a spline connection;

FIG. 8 is a perspective view of the wheel end assembly, with a portion of the wheel end assembly cut away; and

FIG. 9 is side view of a torque gun and wheel end assembly during a rundown of a fastener in accordance with the invention.

### DETAILED DESCRIPTION OF THE PREFERRED EMBODIMENTS

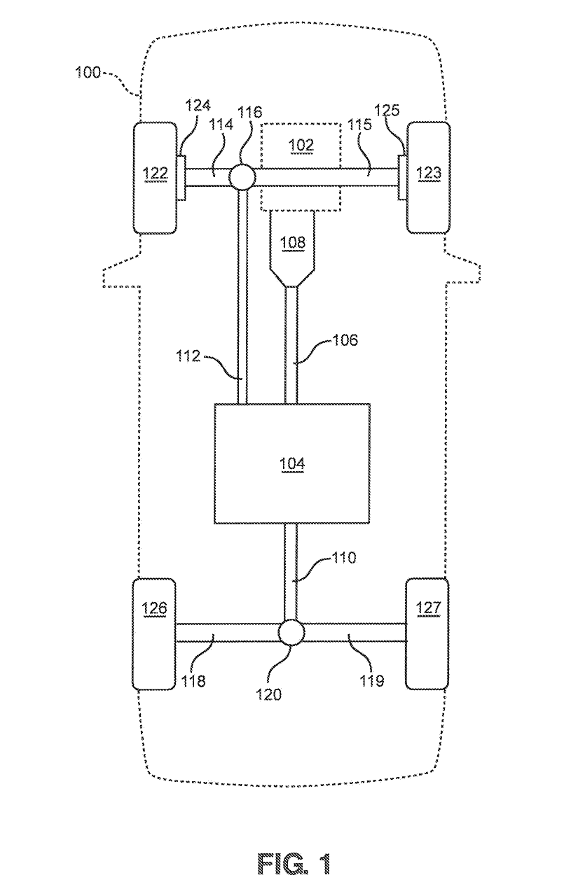

With initial reference to FIG. 1, there is shown a four-wheel drive vehicle 100. Torque generated by an engine 102 is delivered to a transfer case 104 through an input shaft 106, which is coupled to a transmission 108. Engine 102 is preferably an internal combustion engine or an electric motor, for example. Primary and secondary driveshafts 110, 112 selectively receive torque from engine 102 through transfer case 104. Transfer case 104 typically includes a planetary gearing assembly and a conventional electromagnetic clutch assembly, which selectively and cooperatively transfer torque to primary and secondary driveshafts 110, 112. In this particular embodiment, primary driveshaft is a rear driveshaft and secondary driveshaft is a front driveshaft. However, it should be appreciated that, in an alternate embodiment, the primary and secondary driveshafts are interchanged (i.e., the front driveshaft may be the primary driveshaft).

Front half shafts 114, 115 are coupled to and receive torque from secondary driveshaft 112 through a front differential assembly 116. Rear half shafts 118, 119 are coupled to and receive torque from primary driveshaft 110 through a rear differential assembly 120. Front wheels 122, 123 are coupled to hub bearing assemblies 124, 125, which are in turn coupled to front half shafts 114, 115, while rear wheels 126, 127 are coupled to rear half shafts 118, 119. In a two-wheel drive mode, hub bearing assemblies 124, 125 are uncoupled from front half shafts 114, 115 so that hub bearing assemblies 124, 125 do not receive torque from secondary driveshaft 112. Preferably, in the two-wheel drive mode, transfer case 104 does not provide torque to secondary driveshaft 112. In a four-wheel drive mode, hub bearing assemblies 124, 125 are coupled to front half shafts 114, 115 so that hub bearing assemblies 124, 125 do receive torque from secondary driveshaft 112. Because front wheels 122, 123 are coupled to hub bearing assemblies 124, 125, front wheels 122, 123 only receive torque from secondary driveshaft 112 when hub bearing assemblies 124, 125 are driven.

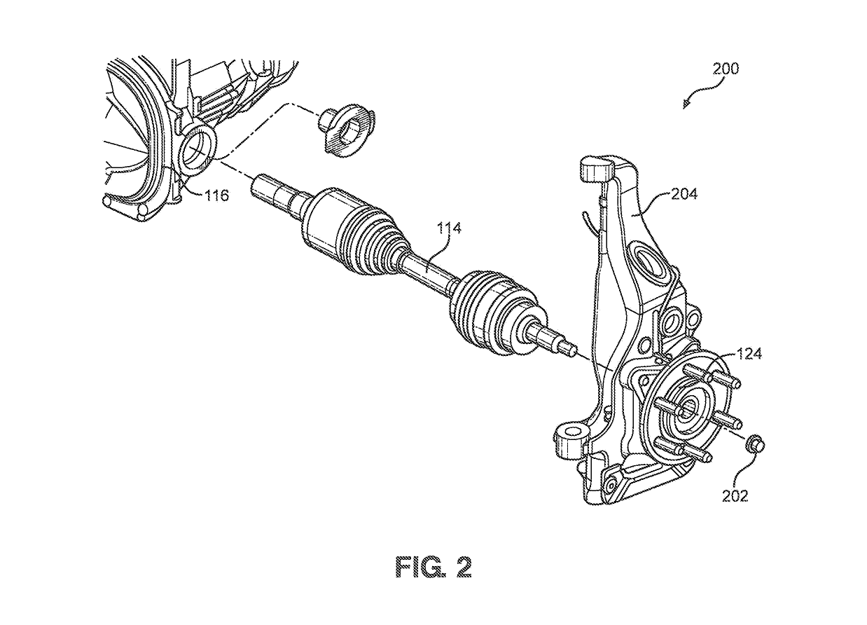

FIG. 2 shows a front, left wheel end assembly 200 of vehicle 100 in greater detail. Wheel end assembly 200 comprises front half shaft 114, hub bearing assembly 124, a fastener 202 and a steering knuckle 204. As described above, a proximal end of half shaft 114 is coupled to front differential assembly 116, while a distal end of half shaft 114 is coupled to hub bearing assembly 124. Differential assembly 116 transmits torque differentially to front half shafts 114, 115. In other words, half shaft 114 can rotate at a different speed from half shaft 115, which enables front wheel 122 coupled to half shaft 114 by hub bearing assembly 124 to rotate at a different speed from front wheel 123 connected to half shaft 115 by hub bearing assembly 125.

Hub bearing assembly 124 is installed in steering knuckle 204 that, during a later assembly step not discussed herein, would itself be coupled to a suspension (not shown) of vehicle 100. Steering knuckle 204 pivots to enable vehicle 100 to be steered.

Fastener 202 is provided in order to securely couple half shaft 114 to hub bearing assembly 124. In a preferred embodiment, fastener 202 is a prevailing torque nut, although fastener 202 can comprise any such fastener that causes half shaft 114 to rotate relative to hub bearing assembly 124 when fastener 202 is run down, as discussed below. For example, fastener 202 can comprise any suitable type of lock nut, of which a prevailing torque nut is one type.

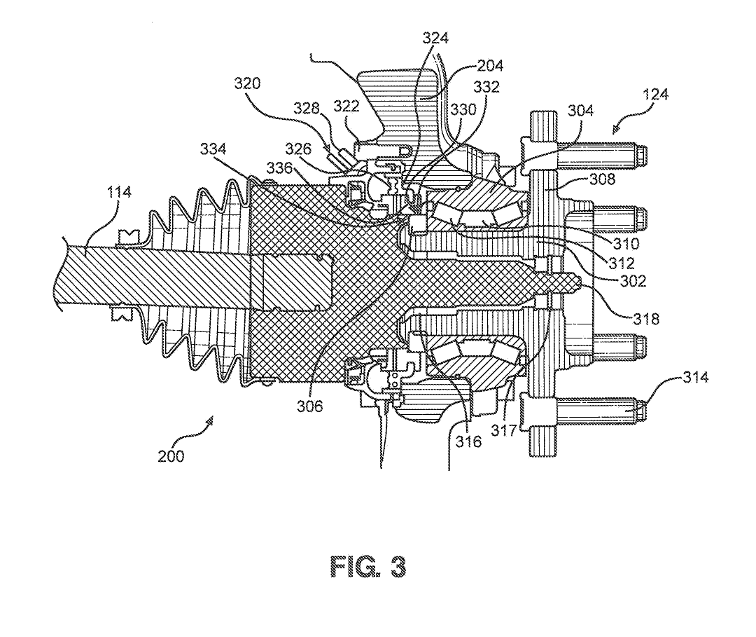

With reference to FIG. 3, it can be seen that hub bearing assembly 124 comprises an inner member 302, an outer member 304, a bearing coupler 306 and a wheel hub portion 308, with wheel hub portion 308 being formed as a portion of inner member 302. As discussed above, hub bearing assembly 124 is installed within steering knuckle 204.

Inner member 302 and outer member 304 of hub bearing assembly 124 define a raceway 310 therebetween. Generally, raceway 310 includes roller elements 312 that allow inner member 302 to rotate relative to outer member 304. A plurality of wheel studs 314 extend from wheel hub portion 308, which is formed as a portion of inner member 302. Wheel studs 314 are configured to engage and support wheel 122. As a result, when half shaft 114 causes inner member 302 to rotate, as described below, wheel 122 will also be caused to rotate. Bearings 316, 317 are provided on half shaft 114 in order to facilitate rotation of inner member 302 with half shaft 114. Bearings 316, 317 may also serve as seals, which prevent contaminants, such as dirt, water or salt, from entering hub bearing assembly 124. Half shaft 114 has a threaded portion 318, at its distal end, on which fastener 202 will be run down and tightened.

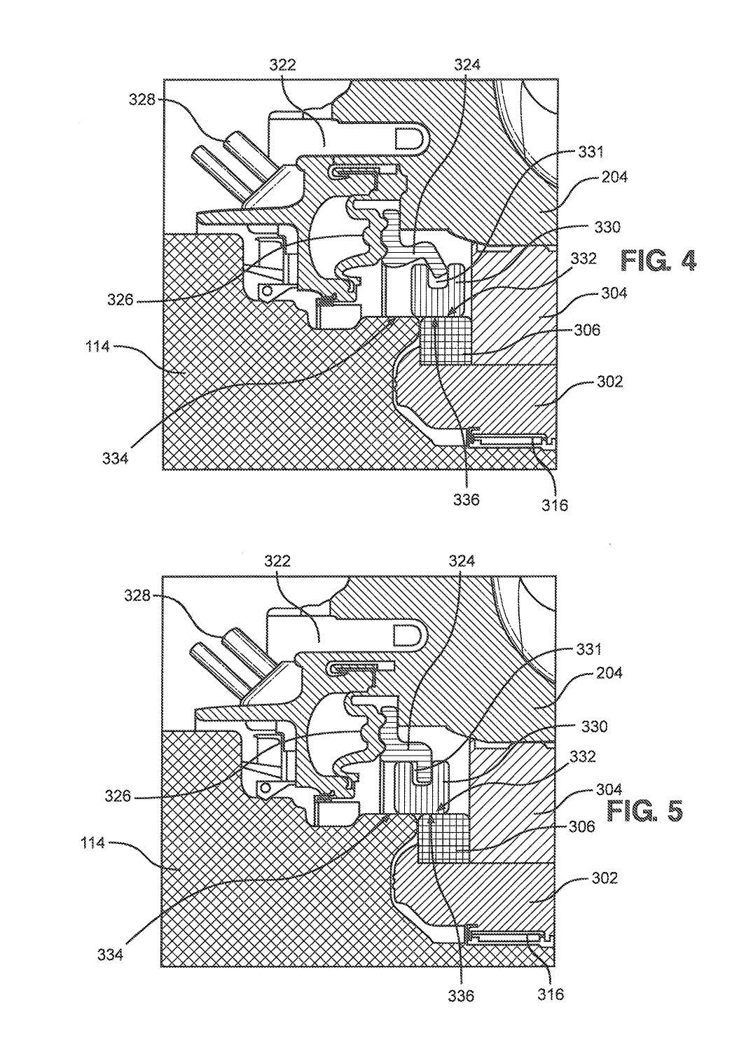

A wheel end actuator 320 is coupled to steering knuckle 204 by at least one fastener 322, which may be a bolt, for example. Wheel end actuator 320 includes a shift fork 324, a diaphragm 326 and a vacuum line 328. When a vacuum is applied to vacuum line 328, diaphragm 326 causes shift fork 324 to move toward the proximal end of half shaft 114 (i.e., to the left in FIG. 3). When the vacuum ceases, diaphragm 326 will cause shift fork 324 to move back toward the distal end of half shaft 114 (i.e., to the right in FIG. 3). As best shown in FIGS. 4-6, a ring gear 330 is coupled to shift fork 324 so that ring gear 330 moves in the same direction as shift fork 324. Specifically, ring gear 330 includes a groove 331 into which a portion of shift fork 324 is inserted. Ring gear 330 includes ring gear splines 332 on an inner surface thereof, which mesh with half shaft splines 334, located on an outer surface of half shaft 114, and bearing splines 336, located on an outer surface of bearing coupler 306. This arrangement can be seen in FIGS. 4-6.

During the assembly process, it is important that half shaft splines 334 and bearing splines 336 are properly aligned. If splines 334, 336 are not aligned, then, as half shaft 114 is inserted into hub bearing assembly 124, half shaft splines 334 will not mesh with ring gear splines 332 and ring gear 330 will be forced toward the distal end of half shaft 114 (i.e., to the right, as shown in FIG. 4). This causes shift fork 324 to become deflected. If nothing is done to remedy this situation, shift fork 324 can be fractured by the large forces applied to it during rundown of fastener 202 on threaded portion 318. Fracturing of shift fork 324 will lead to noise, vibration and harshness (NVH) concerns for a driver of vehicle 100 because ring gear 330 is allowed to move freely within wheel end assembly 200 when not retained by shift fork 324. Additionally, if shift fork 324 fails completely, then it will not be possible to move ring gear 330, in which case, it will not be possible for vehicle 100 to enter the four-wheel drive mode, as will become apparent from the discussion below.

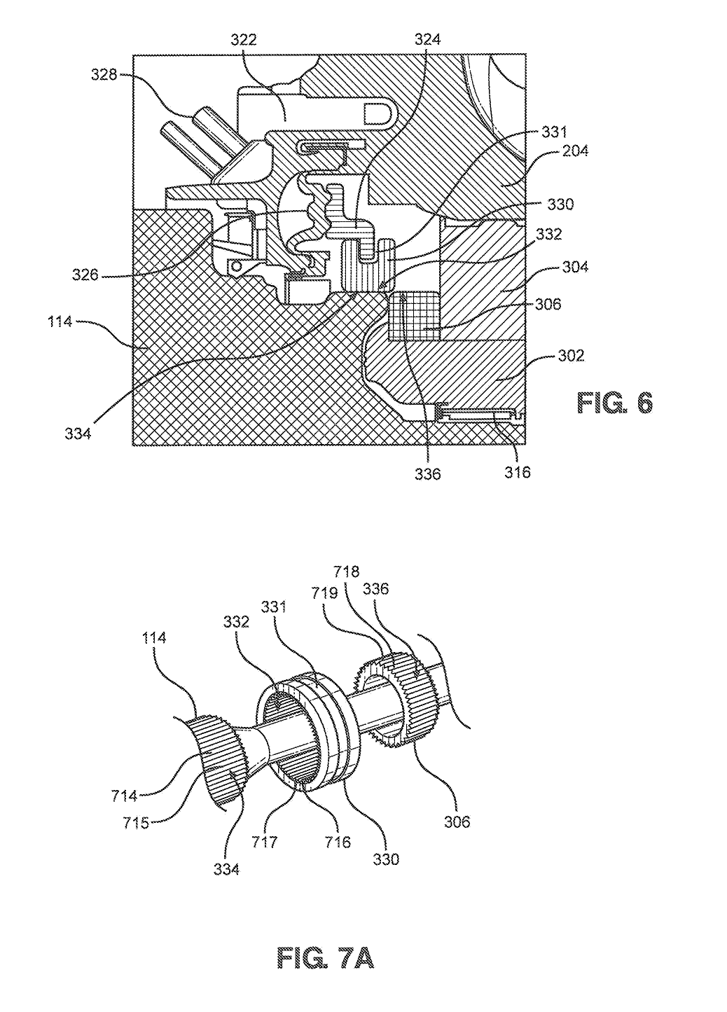

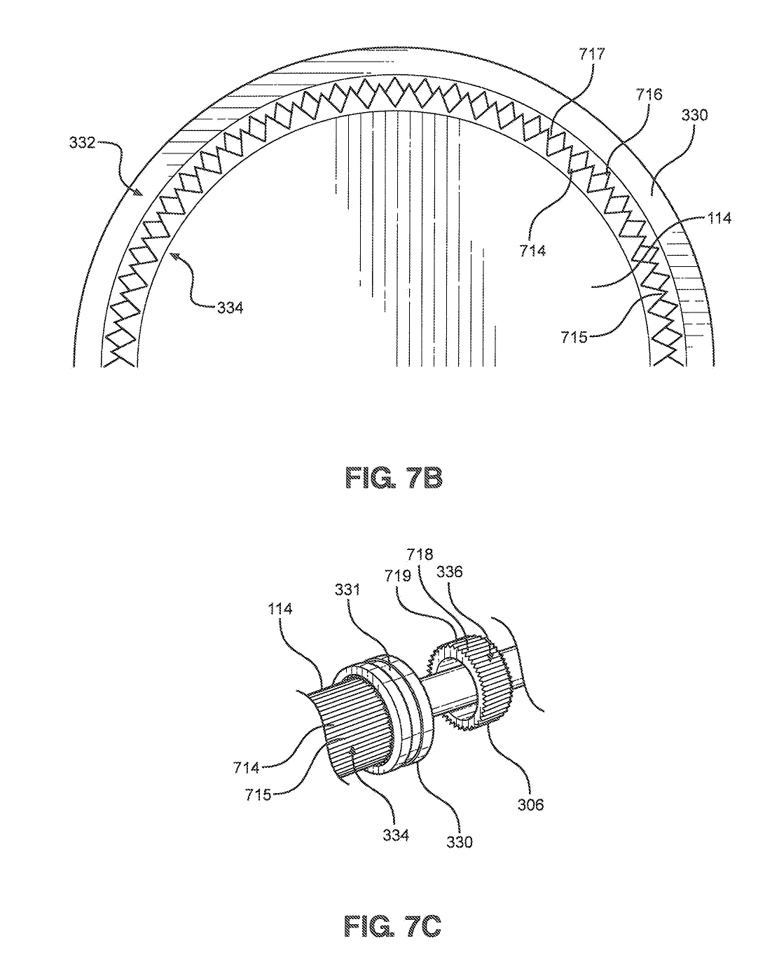

In contrast, when half shaft splines 334 are aligned with bearing splines 336, then, as half shaft 114 is inserted into hub bearing assembly 124, half shaft splines 334 will appropriately mesh with ring gear splines 332 and ring gear 330 will remain in place, as shown in FIG. 5. In this position, which is the default position, ring gear splines 332 simultaneously mesh with both half shaft splines 334 and bearing splines 336. Additionally, shift fork 324 is not deflected, and, therefore, will not become fractured during rundown of fastener 202. As will be explained further below, rotating half shaft 114 when splines 332, 334 and 336 are all in mesh will cause inner member 302 to rotate, which, in turn, causes front wheel 122 coupled thereto to rotate. In other words, in this default position, vehicle 100 is in four-wheel drive mode. As discussed above, when a vacuum is applied to vacuum line 328, shift fork 324, and hence ring gear 330, will move toward the proximal end of half shaft 114 (i.e., to the left in FIGS. 4-6). In that position, shown in FIG. 6, ring gear splines 332 will only be meshed with half shaft splines 334 and vehicle 100 will operate in two-wheel drive mode.

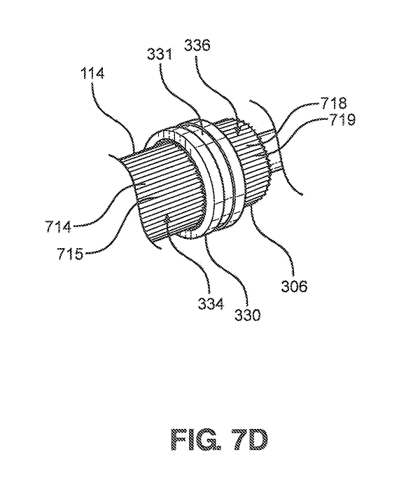

In order to more clearly explain the meshing of the various splines, reference will first be made to FIGS. 7A-D, which show ring gear 330, half shaft 114 and bearing coupler 306 with splines 332, 334, 336 formed thereon.

In general, FIG. 7A shows half shaft 114 with half shaft splines 334 on an outer surface thereof, bearing coupler 306 with bearing splines 336 on an outer surface thereof and a ring gear 330 with ring gear splines 332 on an inner surface thereof. In this particular embodiment, splines 332, 334, 336 are generally triangular in shape, although splines 332, 334, 336, as well as any other splines described in this application, may be other shapes, such as a squares or rectangles. As a result, there are valleys 714, 716, 718 formed between adjacent spline peaks 715, 717, 719. Each of half shaft 114 and bearing coupler 306 is sized so as to fit within ring gear 330, with peaks 715, 719 of splines 334, 336 fitting within valleys 716 formed by splines 332 and peaks 717 of splines 332 fitting within valleys 714, 718 formed by splines 334, 336. If, however, peaks 715, 717, 719 and valleys 714, 716, 718 are not aligned, then peaks 715, 717, 719 will make contact with one another, as shown in FIG. 7B. Specifically, FIG. 7B shows peaks 715 of splines 334 contacting peaks 717 of splines 332. In such a position, splines 334 of half shaft 114 will not mesh with splines 332 of ring gear 330 and it will not be possible to insert half shaft 114 into ring gear 330.

In a situation where half shaft 114 is located within ring gear 330 with splines 332 and splines 334 properly meshed, as shown in FIG. 7C, ring gear 330 can slide along half shaft 114 in a direction generally parallel with peaks 715, 717, 719 and valleys 714, 716, 718. If bearing coupler 306 is located adjacent half shaft 114, then ring gear 330 could potentially slide from half shaft 114 to bearing coupler 306. However, in order for this to occur, peaks 715 and valleys 714 of splines 334 located on half shaft 114 must be respectively aligned with peaks 719 and valleys 718 of splines 336 located on bearing coupler 306. If peaks 715 and valleys 714 are not aligned with peaks 719 and valleys 718, ring gear 330 will be unable to transition from half shaft 114 to bearing coupler 306. If peaks 715 and valleys 714 are aligned with peaks 719 and valleys 718, ring gear 330 can slide to a position where splines 332 are simultaneously meshed with splines 334 and splines 336, as shown in FIG. 7D. In this position, rotating any of half shaft 114, bearing coupler 306 or ring gear 330 will cause the other two to rotate as well.

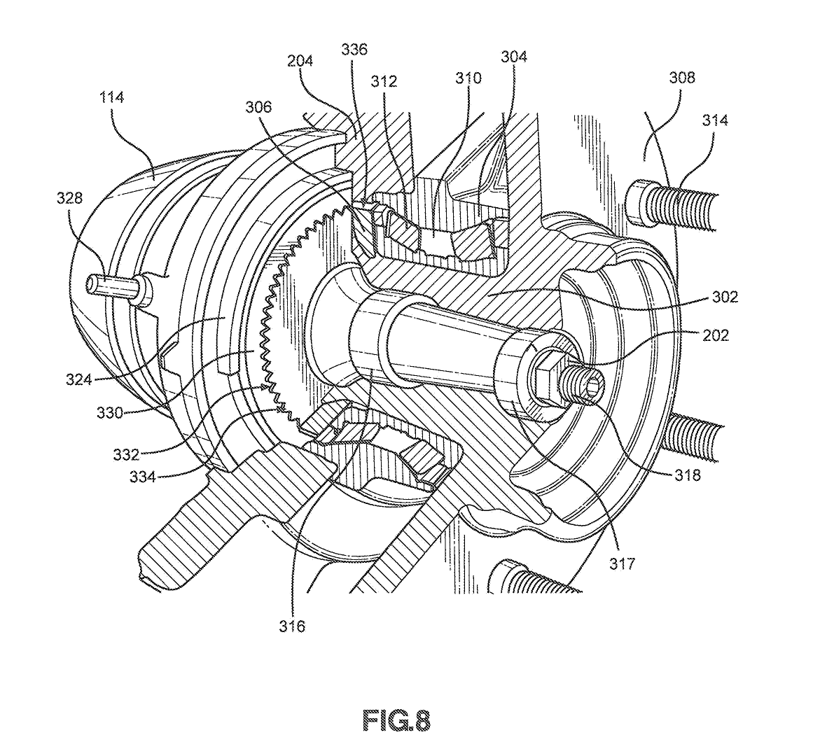

With reference to FIG. 8, ring gear splines 332 can be clearly seen meshed with half shaft splines 334. Additionally, bearing splines 336 can be seen on bearing coupler 306 of hub bearing assembly 124. When half shaft 114 and its half shaft splines 334 are properly aligned with bearing coupler 306 and its bearing splines 336, then ring gear 330 and its ring gear splines 332 can slide back and forth along half shaft splines 334 and bearing splines 336. This enables the positioning shown in FIG. 5, with shift fork 324 in an undeflected position and with ring gear splines 332 simultaneously meshed with both half shaft splines 334 and bearing splines 336. Since splines 332, 334, 336 are all in mesh, and because bearing coupler 306 is coupled to inner member 302 of hub bearing assembly 124, rotating half shaft 114 will cause inner member 302 to rotate. As a result, wheel 122 coupled to wheel hub portion 308 of inner member 302 will, of course, also rotate.

The method of aligning half shaft splines 334 and bearing splines 336 during assembly will now be described. Wheel end actuator 320, which holds ring gear 330 in place through shift fork 324, resists the movement of ring gear 330 to a position closer to the distal end of half shaft 114 (i.e., to the right in FIGS. 4-6) than that shown in FIG. 5. Specifically, the resistance is provided by shift fork 324, which resists the deflection caused by such movement. If half shaft splines 334 are not aligned with bearing splines 336 as half shaft 114 is inserted into hub bearing assembly 124, then half shaft splines 334 will contact ring gear splines 332 and force ring gear 330 toward the position shown in FIG. 4. Half shaft 114 is then rotated relative to hub bearing assembly 124 until half shaft splines 334 become aligned with bearing splines 336. At this point, ring gear 330 will be able to move toward the proximal end of half shaft 114 (i.e., to the left in FIGS. 4-6), and the resistance of shift fork 324 to being deflected will ensure that ring gear 330 does move in that direction. Once this occurs, the meshing of ring gear splines 332, half shaft splines 334 and bearing splines 336 will keep half shaft splines 334 and bearing splines 336 properly aligned unless subjected to a sufficiently large force.

This rotation of half shaft 114 relative to hub bearing assembly 124 is effected through the use of fastener 202. As discussed above, fastener 202 is preferably a prevailing torque nut, but can be another type of lock nut or any other fastener that, when run down, will cause half shaft 114 to rotate relative to hub bearing assembly 124. Specifically, half shaft 114 is caused to rotate because fastener 202 has a high installation torque. In other words, a relatively large amount of torque is required to run down fastener 202. This torque is sufficiently large such that half shaft 114 is also rotated. In one embodiment, at least 20 Nm, and preferably approximately 25 Nm, of torque is required to run down fastener 202, which is also sufficient to rotate half shaft 114. In contrast, a typical fastener might require 10 Nm or less to be run down. In such a case, the fastener would be run down, but half shaft 114 would remain stationary.

Generally speaking, a lock nut is a threaded nut that resists loosening due to vibrations or torque. Prevailing torque nuts are a particular type of lock nut wherein some portion of the nut deforms elastically to provide a locking action. A standard nut has threads that are designed to easily mate with threads on a corresponding male portion. As a result, a relatively smaller amount of torque is required in order to run down a standard nut. In accordance with one embodiment of the present invention, the threads of a nut are altered or deformed so that a relatively large amount of force is required to run down the nut. One way to accomplish this is to change a pitch of the threads so that the pitch does not match a pitch of the threads on the corresponding male portion. Of course, other suitable methods of deforming or altering the threads can also be employed. Additionally, in another embodiment, instead of modifying the threads of the nut, the threads of the corresponding male portion are modified, which, in the embodiments described above, is represented by threaded portion 318 of half shaft 114. Although a standard nylon lock nut may be appropriate for some applications, experimentation with such nuts showed that the nylon simply melted when used in accordance with the embodiments described herein. In other words, various types of lock nuts may be used, but the lock nuts must have a sufficiently high installation torque so that half shaft 114 is rotated during rundown.

An arrangement wherein the alignment of splines occurs during a rundown of a fastener, as described above, is especially advantageous because it ensures that alignment occurs during the final assembly step (i.e., at the last possible moment). If the alignment were to occur prior to the rundown of the fastener, as is conventional, then it is possible that the rundown itself, or some other intermediate event, could move the splines back out of alignment. It is important that the splines are in alignment during the rundown because it is the forces applied at this time that can lead to a fractured shift fork.

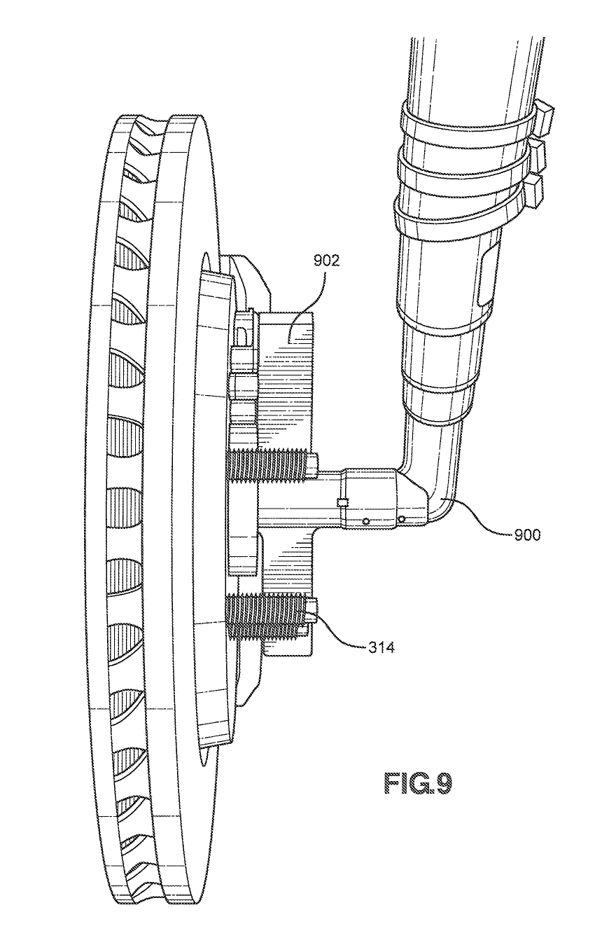

The rundown of fastener 202 is accomplished through the use of a torque gun 900, which is shown in FIG. 9. As fastener 202 is run down, the large amount of torque provided will rotate half shaft 114 relative to hub bearing assembly 124 until half shaft splines 334 become aligned with bearing splines 336. At this point, ring gear 330 will move; ring gear splines 332, half shaft splines 334 and bearing splines 336 will mesh; and inner member 302 of hub bearing assembly 124 will begin to rotate. In order to stop the rotation, torque gun 900 has a torque arm 902 that catches wheel studs 314, which extend from wheel hub portion 308 of inner member 302. Once this occurs, fastener 202 is tightened to a specified torque target, which, in one embodiment, is 40 Nm. Because splines 332, 334, 336 were all meshed when fastener 202 was tightened, shift fork 324 was not deflected during the tightening of fastener 202, and, therefore, was not damaged by the forces exerted during this process.

Once fastener 202 has been tightened, ring gear splines 332, half shaft splines 334 and bearing splines 336 will remain meshed until a vacuum is applied by vacuum line 328 during operation of vehicle 100. As discussed above, this vacuum will cause ring gear 330 to move to the position shown in FIG. 6, wherein ring gear splines 332 mesh only with half shaft splines 334. When this vacuum ceases, half shaft splines 334 and bearing splines 336 may not be in alignment. However, in such a case, ring gear 330 will simply remain in the position shown in FIG. 6 until half shaft splines 334 and bearing splines 336 reenter alignment, at which point ring gear 330 will move to the position shown in FIG. 5. Once fully assembled, it is not possible for ring gear 330 to move into the position shown in FIG. 4, and, therefore, it is not possible to fracture shift fork 324 after assembly is complete.

Although described with reference to preferred embodiments of the invention, it should be readily understood that various changes or modifications could be made to the invention without departing from the spirit thereof. For instance, the front driveshaft could be the primary driveshaft while the rear driveshaft is the secondary driveshaft. In addition, although reference is made to a half shaft and a hub bearing assembly, other driveline components could be used in connection with the present invention. For example, a single driveshaft could be used rather than two half shafts. In general, the invention is only intended to be limited by the scope of the following claims.

1. A method of assembling driveline components for a motor vehicle comprising:
aligning a first driveline component and a second driveline component by rotating one of the first or second driveline components relative to the other; and
securing the first driveline component and the second driveline component with a fastener, wherein rotation of the one of the first or second driveline components relative to the other is accomplished by applying a torque to the fastener.

2. The method of claim 1, wherein aligning the first driveline component and the second driveline component takes place between a spline on the first driveline component and a spline on the second driveline component.

3. The method of claim 1, wherein one of the first or second components includes a threaded portion, and wherein securing the first component and the second component includes running down the fastener on the threaded portion.

4. The method of claim 3, further comprising applying at least 20 Nm of torque to the fastener when running down the fastener.

5. The method of claim 4, further comprising applying 40 Nm of torque to the fastener to tighten the fastener.

6. A method of assembling driveline components for a motor vehicle comprising:
relatively rotating first and second driveline components, until the first and second driveline components are aligned;
wherein the relative rotation of the first or second driveline components occurs when a fastener is run down and tightened on one of the first or second driveline components.

7. The method of claim 6, wherein running down and tightening the fastener is a final assembly step of the first and second driveline components.

8. The method of claim 6, wherein the first driveline component is rotated relative to the second driveline component, and wherein the fastener is run down and tightened on the first driveline component.

9. A motor vehicle comprising:
at least two driveline components; and
a prevailing torque fastener coupling the at least two driveline components.

10. The motor vehicle of claim 9, wherein the at least two driveline components includes a half shaft and a hub bearing assembly.

11. The motor vehicle of claim 10, wherein the half shaft has a first set of threads, and wherein the prevailing torque fastener couples the half shaft and the hub bearing assembly when the prevailing torque fastener is located on the first set of threads.

12. The motor vehicle of claim 11, wherein the prevailing torque fastener is configured to provide at least 20 Nm of torque on one of the at least two driveline components during a rundown of the prevailing torque fastener.

13. The motor vehicle of claim 12, wherein the prevailing torque fastener has a second set of threads, and wherein the first set of threads does not match the second set of threads.

14. The motor vehicle of claim 13, wherein the first or second set of threads is altered or deformed.

15. The motor vehicle of claim 13, wherein the motor vehicle is a four-wheel drive vehicle.

16. The motor vehicle of claim 13, wherein the at least two driveline components includes a first driveline component and a second driveline component, and further wherein the first driveline component has splines and the second driveline components has splines that are aligned with the splines of the first driveline component.

17. The motor vehicle of claim 16, further comprising:
a ring gear including splines and mounted on one of the first or second driveline components; and
a shift fork coupled to the ring gear and configured to move the ring gear to engage the splines of both driveline components, thus providing a four-wheel drive mode.

18. An assembly of splined driveline components for a motor vehicle comprising:
a first driveline component;
a second driveline component arranged for connection with the first driveline component; and
a prevailing torque fastener for securing the first driveline component to the second driveline component, said fastener configured to rotate and align the first driveline component relative to the second driveline component when a torque is applied to the fastener.

19. The assembly of claim 18, wherein the first driveline component includes a first set of splines and the second driveline component includes a second set of splines, and wherein the first and second sets of splines are relatively aligned by relatively rotating the first and second driveline components.

20. The assembly of claim 18, wherein one of the first or second driveline components includes a threaded portion, and wherein the first and second driveline components are secured to one another by running down the fastener on the threaded portion.

21. The assembly of claim 20, wherein at least 20 Nm of torque is applied to the fastener when running down the fastener on the threaded portion.

22. The assembly of claim 21, wherein at least 40 Nm of torque is applied to the fastener to tighten the fastener.
